(19) United States
(12) Patent Application Publication
(10) Pub. No.: US 2015/0220549 A1
(43) Pub. Date: Aug. 6, 2015

(54) METHOD AND DEVICE FOR FILTERING GARBAGE DATA

(71) Applicant: TENCENT TECHNOLOGY (SHENZHEN) COMPANY LIMITED, Futian Distriant, Shenzhen, Guangdong (CN)

(72) Inventors: Haifeng Jin, Shenzhen (CN); Liqun Fu, Shenzhen (CN); Rui Li, Shenzhen (CN); Tao Dong, Shenzhen (CN)

(73) Assignee: TENCENT TECHNOLOGY (SHENZHEN) COMPANY LIMITED, Shenzhen, Guangdong (CN)

(21) Appl. No.: 14/426,939

(22) PCT Filed: Sep. 3, 2013
(86) PCT No.: PCT/CN2013/082825

§ 371 Date: Mar. 9, 2015

(30) Foreign Application Priority Data
Sep. 10, 2012 (CN) 201210332055.3

(51) Int. Cl. G06F 17/30

(52) U.S. Cl. CPC G06F 17/30115

(57) ABSTRACT

A method for filtering garbage data, including: a garbage data path value and a garbage data filtering rule are preset, based on an instruction received from the outside; a garbage data scanning point is determined, by parsing the garbage data path value; each file in the garbage data scanning point is scanned, so as to determine whether the each file is the garbage data, based on the garbage data filtering rule.

The application claims priority to a Chinese patent application 201210332055.3, titled “Method and Device for Filtering Garbage Data”, which was filed on Sep. 10, 2012. The disclosures of the application No. 201210332055.3 are incorporated here by reference in its entirety.

### TECHNICAL FIELD

The present disclosure relates to computer data technologies, and more particularly, to a method and device for filtering garbage data.

### BACKGROUND

In the process of using a computer, each computer software, including an Operating System (OS), may generate some additional data files to record operating parameters at that time. These data files are only valid at that time, which may become garbage data subsequently. A computer user may not care about the garbage data, even cannot understand the garbage data. However, the OS and application software may not actively remove the garbage data. Subsequently, a large number of storage resources of a user computer may be occupied by residual garbage data.

At present, there is no unified standard for format and storage location of garbage data. Since a determining condition about filtering rule of garbage data is complicated, the existing method for filtering garbage data may be generally implemented with a hard-coded program. Thus, a filtering rule, which may be not updated in real time, can not be defined by a user.

### SUMMARY

An example of the present disclosure provides a method for filtering garbage data, which may support a user-defined rule for filtering garbage data, so as to update a filtering rule in real time.

An example of the present disclosure provides a device for filtering garbage data, which may support a user-defined rule for filtering garbage data, so as to update a filtering rule in real time.

Technical solutions of the present disclosure are as follows.

A method for filtering garbage data, including:
presetting a garbage data path value and a garbage data filtering rule, based on an instruction received from the outside;
determining a garbage data scanning point, by parsing the garbage data path value;
scanning each file in the garbage data scanning point, and determining whether the each file is the garbage data, based on the garbage data filtering rule.

A device for filtering garbage data, including a memory, and a processor in communication with the memory, wherein the memory stores the following instructions executable by the processor;
a presetting instruction, which indicates to preset a garbage data path value and a garbage data filtering rule, based on an instruction received from the outside;
a parsing instruction, which indicates to determine a garbage data scanning point, by parsing the garbage data path value; and
a scanning instruction, which indicates to scan each file in the garbage data scanning point, and determine whether the each file is the garbage data, based on the garbage data filtering rule.

Thus, it can be seen that, in accordance with the method and device for filtering garbage data provided by examples of the present disclosure, a user-defined rule for filtering garbage data may be supported, in which the user-defined rule may be created by inputting an instruction. Subsequently, real-time updating and network operations of a filtering rule may be implemented.

### BRIEF DESCRIPTIONS OF THE DRAWINGS

FIG. 1 is a flowchart illustrating a method for filtering garbage data, in accordance with an example of the present disclosure.

FIG. 2 is a schematic diagram illustrating an interface for setting an absolute path, in accordance with an example of the present disclosure.

FIG. 3 is a schematic diagram illustrating an interface for setting a registry path, in accordance with an example of the present disclosure.

FIG. 4 is a schematic diagram illustrating how to parse a garbage data path value, in accordance with an example of the present disclosure.

FIG. 5 is a schematic diagram illustrating structure of a device for filtering garbage data, in accordance with an example of the present disclosure.

FIG. 6 is a schematic diagram illustrating another structure of a device for filtering garbage data, in accordance with an example of the present disclosure.

### DETAILED DESCRIPTIONS

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. In addition, the terms “a” and “an” are intended to denote at least one of a particular element.

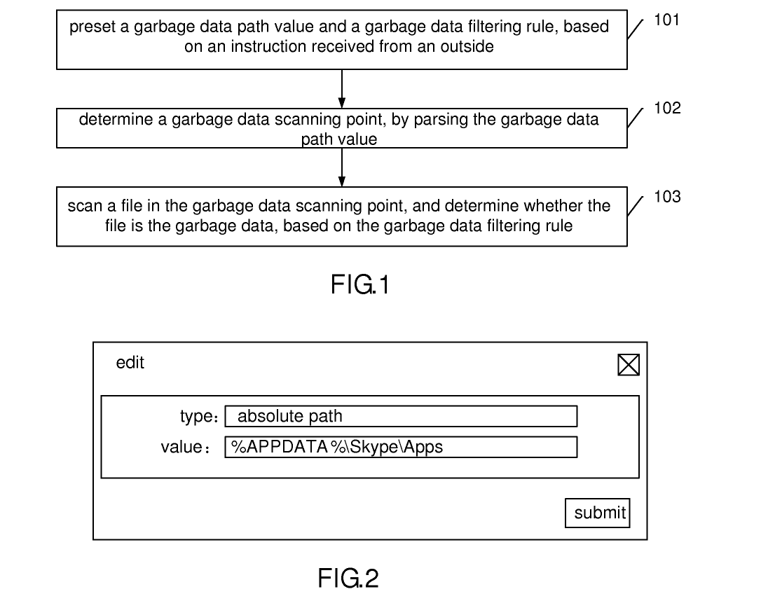

FIG. 1 is a flowchart illustrating a method for filtering garbage data, in accordance with an example of the present disclosure. As shown in FIG. 1, the method may include the following blocks.

In block 101, preset a garbage data path value and a garbage data filtering rule, based on an instruction received from the outside.

In block 102, determine a garbage data scanning point by parsing the garbage data path value.

In block 103, scan each file in the garbage data scanning point, and determine whether the each file is garbage data based on the garbage data filtering rule.

In the foregoing block 101, the garbage data path value preset may be an absolute path, a registry path or an initial (ini) file path. The instruction received from the outside may be transmitted by a person, who uses or develops a garbage data filtering system, or may be transmitted by a person who develops the software generating the garbage data. Alternatively, the garbage data path value may be set by a third party, by using an interactive operating interface. For example, FIG. 2 is a schematic diagram illustrating an interface for setting an absolute path, in accordance with an example of the present disclosure. FIG. 3 is a schematic diagram illustrating an interface for setting a registry path, in accordance with an example of the present disclosure.

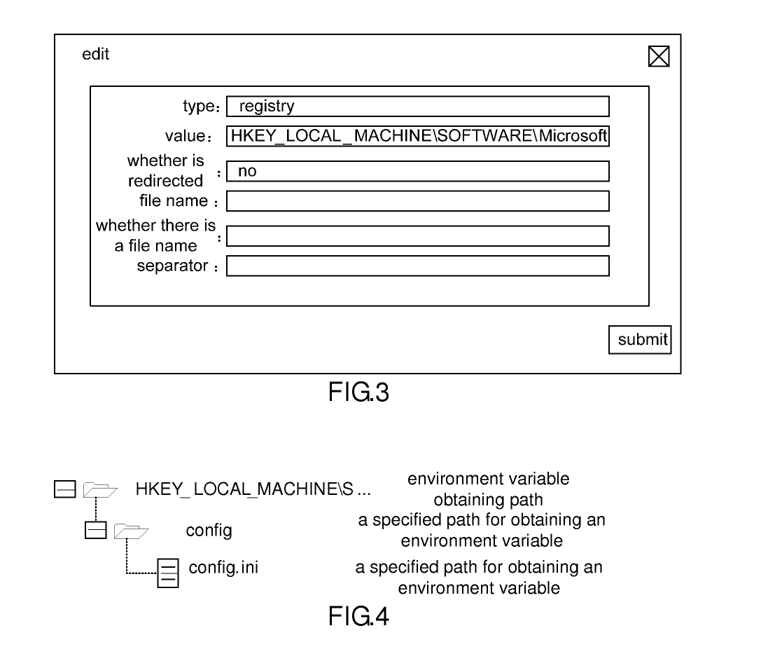

In block 102, the garbage data path value repeatedly redirected may be parsed, by using the tree structure shown in FIG. 4. Firstly, read a registry value (HKEY_LOCAL_MACHINE\S . . . ), which points to an ini path (config). And then, obtain the garbage data scanning point (config.ini) pointed by the ini path.

The garbage data scanning point is a location, where the garbage data is stored. The garbage data scanning point may also store other useful data. Thus, it is necessary to execute block 103. That is, scan each file in the garbage data scanning point, so as to determine which file is the garbage data, based on the garbage data filtering rule.

The garbage data filtering rule used in block 103 may include a garbage data basic judgment relationship and a garbage data combination judgment relationship. The garbage data basic judgment relationship is as follows. When data of which is compared and data of a comparator meet a preset condition relationship, determine that the data of which is compared is the garbage data. Alternatively, when data of which is compared and data of a comparator meet a preset condition relationship, determine that the data of which is compared is not the garbage data. The garbage data combination judgment relationship uses at least one of “&&” and “∥” to combine two or more than two garbage data basic judgment relationships.

Specifically speaking, the garbage data basic judgment relationship may take the Extensible Markup Language (XML) as a rule carrier. The XML form may be as follows.

| | |
|---|---|
| <!DOCTYPE | filters [ |

| | |
|---|---|
| <!ELEMENT filter | EMPTY> |

| | | | |
|---|---|---|---|
| <!ATTLIST filter | name | ID | #REQUIRED> |

| <!ATTLIST filter | column | CDATA #REQUIRED> |
|---|---|---|
| <!ATTLIST filter | relation CDATA #REQUIRED> | |
| <!ATTLIST filter | value | CDATA #IMPLIED> |
| <!ATTLIST filter | action | CDATA #REQUIRED> |

]>

Based on the foregoing XML form, the garbage data basic judgment relationship may be defined in the manner of an XML statement. For example, <filter name=“filter5” column=“filename” relation=“is” value=“swflash.inf” action=“exclude”/>.

Explanations about the foregoing garbage data basic judgment relationship are as follows.

In the following examples of the present disclosure, filter represents a filtering rule. Name attribute is a unique global identifier of filter. A filter may be used with a name.

Column attribute is data of which is compared. Data of which is compared may be obtained by using the column value, e.g., a file name, a file path, or a file create time of which is compared, and so on.

Relation attribute is a relationship attribute. That is, the condition relationship between data of which is compared and data of a comparator, such as data of which is compared is the data of the comparator, data of which is compared is begun with the data of the comparator, or, data of which is compared is ended with the data of the comparator.

Value attribute is data of the comparator. The data of the comparator may be obtained by directly getting value of the value attribute, e.g., a user-defined string, such as .bif.

Action attribute is an action to be executed, when the condition relationship between the data of which is compared and the data of the comparator is established, e.g., exclude and include. When the condition relationship is established and the action attribute is “include”, the data of which is compared may be considered as the garbage data. When the condition relationship is established and the action attribute is “exclude”, the data of which is compared may be not considered as the garbage data.

A relationship may be determined by using a single filter. In the judgment process, the column is taken as the data of which is compared, relation is taken as the condition relationship, value is taken as the data of the comparator. Thus, it may be learned that whether the data of which is compared and the data of the comparator meet descriptions of the condition relationship. Based on the result of the condition relationship, all of the single judgment logic may be included, by executing a corresponding operation based on the action. For example, determine a file is the garbage data when the filename is “name”. The foregoing filter may be written with the following form, <filter name=“filtername1” column=“filename” relation=“is” value=“name” action=“include”/>.

In the garbage data basic judgment relationship put forward by an example of the present disclosure, the data of which is compared, the condition relationship, the data of the comparator and the action may be extended by using the attribute. Subsequently, whether the data is the garbage data may be determined from multiple directions and multiple latitudes. The garbage data basic judgment relationship may support currently popular condition relationships, such as whether file path is a specified string, whether file size is larger than or smaller than a preset size, whether the file create time is in line with expectation, and so on. New condition relationships may be added in the subsequent usage process, such as a final modified date of a file, a final modified person of a file, and so on.

The garbage data combination judgment relationship may be introduced as follows.

The garbage data combination judgment relationship is multiple uses for multiple garbage data basic judgment relationships. The garbage data combination judgment relationship may use at least one of “&&” and “∥” to combine two or more than two garbage data basic judgment relationships.

All of the relationships in practice may be represented by at least one of “&&” and “∥”. Table 1 illustrates some examples about logical representation of some relationships. More relationships may be increased one by one, which will not be listed here.

TABLE 1

| relationship | logical representation |
|---|---|
| a or b or c | a∥b∥c |
| a or b and c | a∥(b&&c), (a∥b)&&c |
| a and b or c | (a&&b)∥c, a&&(b∥c) |
| a and b and c | a&&b&&c |

In the example of the present disclosure, a single garbage data basic judgment relationship may be correspondingly used by adopting each relationship. Meanwhile, number of garbage data basic judgment relationship is not limited to 3. Multiple relationships may be simultaneously used. A very complicated judgment process may be generated by simultaneously using multiple relationships.

In an example of the present disclosure, in a specific judgment process about garbage data, an XML statement may be similarly used to record the garbage data combination judgment relationship.

<filters=”filtername1||(filtername2&&filtername3)”>
<filter name=″filtername1″ column=″filename″ relation=″end with″
value=″.log″ action = ″include″/>
<filter name=″filtername2″ column=″filename″ relation=″end with″
value=″.txt ″ action = ″include″/>
<filter name=″filtername3″ column=″filename″ relation=″begin with″
value=″start″ action = ″include″/>

In the foregoing statement, filters is a garbage data combination judgment relationship. Filtername 1, filtername 2 and filtername 3 are three garbage data basic judgment relationships. Filters may employ “&&” and “∥” to combine these three garbage data basic judgment relationships. Filtername 1 demonstrates that data of a file, the filename of which is ended with .log, is the garbage data. Filtername 2 demonstrates that data of a file, the filename of which is ended with .txt, is the garbage data. Filtername 3 demonstrates that data of a file, the filename of which is begun with start string, is the garbage data. Subsequently, filters demonstrates that data of a file, the filename of which is ended with .log, is the garbage data, or the data of a file, the filename of which is ended with .txt and begun with start, is the garbage data.

The foregoing example only demonstrates one form of the garbage data combination judgment relationship. In a specific implementation process, a judgment logic may be more complicated by editing filters, so as to enable judgment about the garbage data is more accurate.

An example of the present disclosure also provides a device for filtering garbage data. FIG. 5 is a schematic diagram illustrating structure of a device for filtering garbage data, which includes a presetting module 501, a parsing module 502 and a scanning module 503.

The presetting module 501 is configured to preset a garbage data path value and a garbage data filtering rule, based on an instruction received from the outside.

The parsing module 502 is configured to determine a garbage is data scanning point, by parsing the garbage data path value.

The scanning module 503 is configured to scan each file in the garbage data scanning point, and determine whether the each file is the garbage data, based on the garbage data filtering rule.

In the foregoing device, the garbage data path value is an absolute path, a registry path or an ini file path.

The garbage data filtering rule includes the garbage data basic judgment relationship, which is as follows. When data of which is compared and data of a comparator meet a preset condition relationship, determine that the data of which is compared is the garbage data. Alternatively, when the data of which is compared and the data of the comparator meet the preset condition relationship, determine that the data of which is compared is not the garbage data.

The data of which is compared includes at least one of a file name, a file path or a file create time of which is compared.

The preset condition relationship is as follows. The data of which is compared is the data of the comparator. The data of which is compared is begun with the data of the comparator. Or, the data of which is compared is ended with the data of the comparator.

The foregoing garbage data filtering rule may also include the garbage data combination judgment relationship. The garbage data combination judgment relationship employs at least one of “&&” and “∥” to combine two or more than two garbage data basic judgment relationships.

The foregoing instruction received from the outside may be transmitted by a person, who uses or develops the garbage data filtering system, or may be transmitted by a person, who develops the software generating the garbage data.

An example of the present disclosure also provides a machine readable storage medium, which may store instructions enabling a machine to execute the method for filtering garbage data as mentioned above. Specifically speaking, a system or device with such storage medium may be provided. The storage medium may store software program codes, which may implement functions of any foregoing example. A computer (or Central Processing Unit (CPU), or Micro Processing Unit (MPU)) of the system or device may read and is execute the program codes stored in the storage medium.

In this case, the program codes read from the storage medium may implement functions of any foregoing example. Thus, the program codes and storage medium may form a part of the present disclosure.

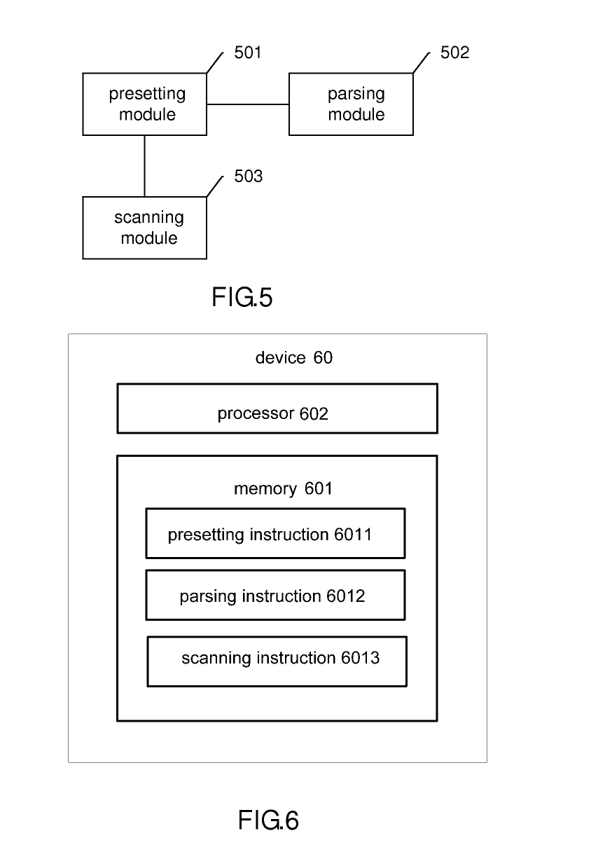

For instance, an example of the present disclosure also provides a device for filtering garbage data. FIG. 6 is a schematic diagram illustrating structure of a device 60 for filtering garbage data, which includes a memory 601, one or more processors in communication with memory 601. To simplify descriptions, suppose there is only one processor 602. Memory 601 is configured to store one or more instructions executable by processor 602. The foregoing one or more instructions include a presetting instruction 6011, a parsing instruction 6012 and a scanning instruction 6013.

The presetting instruction 6011 indicates to preset a garbage data path value and a garbage data filtering rule, based on an instruction received from the outside.

The parsing instruction 6012 indicates to determine a garbage data scanning point, by parsing the garbage data path value.

The scanning instruction 6013 indicates to scan each file in the garbage data scanning point, and determine whether the each file is the garbage data, based on the garbage data filtering rule.

In the foregoing device 60, the garbage data path value is an absolute path, a registry path or an Ini file path.

The garbage data filtering rule includes a garbage data basic judgment relationship, which is as follows. When data of which is compared and data of a comparator meet a preset condition relationship, determine that the data of which is compared is the garbage data. Alternatively, when the data of which is compared and the data of the comparator meet a preset condition relationship, determine that the data of which is compared is not the garbage data.

The data of which is compared includes at least one of a file name, a file path and a file create time of which is compared.

The preset condition relationship may be as follows. The data of which is compared is the data of the comparator. The data of which is compared is begun with the data of the comparator. Or, the data of which is compared is ended with the data of the comparator.

The foregoing garbage data filtering rule may also include the garbage data combination judgment relationship. The garbage data combination judgment relationship may use at least one of “&&” and “∥” to combine two or more than two garbage data basic judgment relationships.

The foregoing instruction received from the outside may be transmitted by a person, who uses or develops the garbage data filtering system, or may be transmitted by a person, who develops the software generating the garbage data.

In view of above, it can be seen that, in accordance with the method and device for filtering garbage data put forward by examples of the present disclosure, a dynamic operation may be implemented, which may be quickly applied to a user. Meanwhile, a user-defined filtering system is allowed, so as to implement a personalized filtering rule. In the examples of the present disclosure, a filtering rule is allowed to be edited by a third party, so as to implement a multi-party cooperation. Besides, by setting the garbage data filtering rule with the method put forward by an example of the present disclosure, a multi-filtering of garbage data may be achieved. And misjudgment possibility may be reduced.

1. A method for filtering garbage data, comprising:
presetting a garbage data path value and a garbage data filtering rule, based on an instruction received from the outside;
determining a garbage data scanning point, by parsing the garbage data path value;
scanning each file in the garbage data scanning point, and determining whether the each file is the garbage data, based on the garbage data filtering rule.

2. The method according to claim 1, wherein the garbage data path value is an absolute path, a registry path or an Ini file path.

3. The method according to claim 1 or 2, wherein the garbage data filtering rule comprises a garbage data basic judgment relationship, which comprises:
when data of which is compared and data of a comparator meet a preset is condition relationship, determining that the data of which is compared is the garbage data; or,
when the data of which is compared and the data of the comparator meet another preset condition relationship, determining that the data of which is compared is not the garbage data.

4. The method according to claim 3, wherein the data of which is compared comprises at least one of: a file name, a file path, and a file create time of which is compared; and
wherein the preset condition relationship comprises: the data of which is compared is the data of the comparator, the data of which is compared is begun with the data of the comparator, or the data of which is compared is ended with the data of the comparator.

5. The method according to claim 3, wherein the garbage data filtering rule comprises a garbage data combination judgment relationship, and the garbage data combination judgment relationship uses at least one of “&&” and “∥” to combine two or more than two garbage data basic judgment relationships.

6. The method according to claim 1, wherein the instruction received from the outside is transmitted by a person, who uses or develops a garbage data filtering system, or is transmitted by a person who develops software generating the garbage data.

7. A device for filtering garbage data, comprising a memory, and a processor in communication with the memory, wherein the memory stores the following instructions executable by the processor;
a presetting instruction, which indicates to preset a garbage data path value and a garbage data filtering rule, based on an instruction received from the outside;
a parsing instruction, which indicates to determine a garbage data scanning point, by parsing the garbage data path value; and
a scanning instruction, which indicates to scan each file in the garbage data scanning point, and determine whether the each file is the garbage data, based on the garbage data filtering rule.

8. The device according to claim 7, wherein the garbage data path value is an absolute path, a registry path or an Ini file path.

9. The device according to claim 7 or 8, wherein the garbage data filtering rule comprises a garbage data basic judgment relationship; and
the garbage data basic judgment relationship comprises: when data of which is compared and data of a comparator meet a preset condition relationship, determining that the data of which is compared is the garbage data;
or, when the data of which is compared and the data of the comparator meet another preset condition relationship, determining that the data of which is compared is not the garbage data.

10. The device according to claim 9, wherein the data of which is compared comprises at least one of: a file name, a file path, and a file create time of which is compared; and
the preset condition relationship comprises: the data of which is compared is the data of the comparator, the data of which is compared is begun with the data of the comparator, or the data of which is compared is ended with the data of the comparator.

11. The device according to claim 9, wherein the garbage data filtering rule comprises a garbage data combination judgment relationship, and
the garbage data combination judgment relationship uses at least one of “&&” and “∥” to combine two or more than two garbage data basic judgment relationships.

12. The device according to claim 7, wherein the instruction received from the outside is transmitted by a person, who uses or develops a garbage data filtering system, or is transmitted by a person who develops software generating the garbage data.
